(19) United States
(12) Patent Application Publication
(10) Pub. No.: US 2009/0024396 A1
(43) Pub. Date: Jan. 22, 2009

(54) AUDIO SIGNAL ENCODING METHOD AND APPARATUS

(75) Inventors: Chul-woo Lee, Suwon-si (KR); Geon-hyoung Lee, Hwanseong-si (KR); Jae-one Oh, Yongin-si (KR); Jong-hoon Jeong, Suwon-si (KR); Nam-suk Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/028,017

(22) Filed: Feb. 8, 2008

(30) Foreign Application Priority Data
Jul. 18, 2007 (KR) 10-2007-0071684

(51) Int. Cl. G10L 19/00

(52) U.S. Cl. 704/500; 704/203; 704/E21.009

(57) ABSTRACT

An audio signal encoding method and apparatus for efficiently encoding an audio signal in an interval having many birth sinusoids and enabling tracking of sinusoidal signals in the next interval, and a computer readable recording medium having embodied thereon a computer program for executing the audio signal encoding method are provided. According to the method and apparatus, by applying transform coding instead of parametric coding to a frame having many birth sinusoids, the sinusoids are encoded, thereby reducing the number of bits required for the encoding and enabling efficient coding. Also, when transform coding is applied to a frame of a predetermined interval, an inverse transform of the transform coding is applied to the encoded data in order to decode the data, and then sinusoids are extracted from the decoded data, thereby enabling tracking of sinusoids of the next frame.

### CROSS-REFERENCE TO RELATED PATENT APPLICATIONS

This application claims priority from Korean Patent Application No. 10-2007-0071684 filed on Jul. 18, 2007, in the Korean Intellectual Property Office, the disclosure of which is incorporated herein in its entirety by reference.

### BACKGROUND OF THE INVENTION

1. Field of the Invention

Apparatuses and methods consistent with the present invention relate to encoding of an audio signal, and more particularly, to efficiently encoding an audio signal in an interval having many birth sinusoids.

2. Description of the Related Art

Parametric coding is a coding method by which an audio signal is expressed by predetermined parameters, and is used in the moving picture experts group 4 (MPEG-4) standard.

FIG. 1 is a diagram for explaining a parametric coding method of the related art. In the parametric coding method of the related art, an input signal is analyzed and parameterized. First, the input signal is appropriately filtered (Audio Reading and Filtering 1).

Referring to FIG. 1, the input audio signal is divided into segment or frame units, and three types of analysis: transient analysis 2, sinusoidal analysis 3, and noise analysis 4, are performed for each frame, thereby extracting parameters for audio components in each area. The transient analysis corresponds to very dynamic audio changes. The sinusoidal analysis corresponds to deterministic audio changes. The noise analysis corresponds to stochastic or non-deterministic changes.

The extracted parameters are formatted as a bitstream (Bit-Stream Formatting 5).

Among transient components, sinusoids, and noise components, the sinusoids have the most important information and require the most bits when encoding.

After performing the sinusoidal analysis, tracking of the sinusoids is performed in order to perform Adaptive Differential Pulse Code Modulation (ADPCM) or Differential Pulse Code Modulation (DPCM) coding of the sinusoids. The tracking of the sinusoids is for determining sinusoids continuing from sinusoids of a previous frame and to set up correspondence relationships. A sinusoid of a current frame which has a characteristic similar to that of a sinusoid of a previous frame and therefore can be tracked from the sinusoid of the previous frame is referred to as a continuation sinusoid. Since difference coding is performed for the continuation sinusoid by using the sinusoid of the previous frame corresponding to the continuation sinusoid, efficient coding is enabled.

Meanwhile, a sinusoid of a current frame that cannot be tracked from sinusoids of a previous frame is referred to as a birth sinusoid. A birth sinusoid means that the sinusoid does not continue from a sinusoid of a previous frame and is newly generated in the current frame. In general, a birth sinusoid cannot be coded by using a sinusoid of a previous frame, and absolute coding is performed. Accordingly, a large number of bits are required for the coding of a birth sinusoid.

Therefore, for an interval having many birth sinusoids, reducing the number of bits required for coding of sinusoids is required by applying a more efficient coding method instead of simply applying ordinary parametric coding.

Meanwhile, when sinusoidal signals in a predetermined interval are coded by applying a more efficient coding method instead of applying simple parametric coding, sinusoidal signals in an interval following the current interval cannot be tracked from the sinusoidal signals of the current interval. Thus, this problem needs to be overcome.

### SUMMARY OF THE INVENTION

The present invention provides an audio signal encoding method and apparatus for efficiently encoding an audio signal in an interval having many birth sinusoids and enabling tracking of sinusoidal signals in the next interval, and a computer readable recording medium having embodied thereon a computer program for executing the audio signal encoding method.

According to an aspect of the present invention, there is provided a method of encoding an audio signal, including: directly extracting sinusoids of an input current frame, by performing sinusoidal analysis of an audio signal of the current frame; obtaining continuation sinusoids and birth sinusoids, by performing tracking of the sinusoids of the current frame, from sinusoids of a previous frame; comparing a first bit number which is the number of bits required for encoding the birth sinusoids by applying parametric coding, with a second bit number which is the number of bits required for encoding the birth sinusoids by applying transform coding, and determining whether or not the first bit number is greater than the second bit number; if the first bit number is less than the second bit number, encoding the sinusoids of the current frame by applying parametric coding; if the first bit number is greater than the second bit number, encoding the sinusoids of the current frame by applying transform coding; if the first bit number is greater than the second bit number, regenerating the audio signal of the current frame, by decoding data which is encoded by applying the transform coding, by applying inverse transform of the transform coding, and extracting the sinusoids of the regenerated audio signal of the current frame, by performing sinusoidal analysis of the regenerated audio signal of the current frame; and performing tracking of the sinusoids of a next frame, by using the sinusoids directly extracted from the audio signal of the input current frame, or by using the sinusoids extracted from the regenerated audio signal of the current frame.

The comparing of the first bit number with the second bit number may include: obtaining a first encoding value, by encoding the birth sinusoids by applying parametric coding; and comparing the number of bits of the first encoding value with a preset threshold.

The comparing of the first bit number with the second bit number may include: obtaining a first encoding value, by applying parametric coding to the birth sinusoids; obtaining a second encoding value, by applying transform coding to the birth sinusoids; and comparing the number of bits of the first encoding value with the number of bits of the second encoding value.

The tracking of the sinusoids of the next frame may include: receiving an audio signal of the next frame; extracting the sinusoids of the next frame, by performing sinusoidal analysis of the audio signal of the next frame; if the first bit number is less than the second bit number, performing tracking of the sinusoids of the next frame from the sinusoids directly extracted from the audio signal of the current frame; and if the first bit number is greater than the second bit number, performing tracking of the sinusoids of the next frame from the sinusoids extracted from the regenerated audio signal of the current frame.

The transform coding may include Advanced Audio Coding (AAC).

According to another aspect of the present invention, there is provided an apparatus for encoding an audio signal, including: a first sinusoidal extraction unit directly extracting sinusoids of an input current frame, by performing sinusoidal analysis of an audio signal of the current frame; a sinusoidal tracking unit obtaining continuation sinusoids and birth sinusoids, by performing tracking of the sinusoids of the current frame from sinusoids of a previous frame; a bit number comparison unit comparing a first bit number which is the number of bits required for encoding the birth sinusoids by applying parametric coding, with a second bit number which is the number of bits required for encoding the birth sinusoids by applying transform coding, and determining whether or not the first bit number is greater than the second bit number; a parametric coding unit, if the first bit number is less than the second bit number, encoding the sinusoids of the current frame, by applying parametric coding; a transform coding unit, if the first bit number is greater than the second bit number, encoding the sinusoids of the current frame, by applying transform coding; and a second sinusoidal extraction unit, if the first bit number is greater than the second bit number, regenerating the audio signal of the current frame, by decoding the encoded data, which is encoded by applying the transform coding, by applying an inverse transform of the transform coding, and extracting the sinusoids from the regenerated audio signal of the current frame, by performing sinusoidal analysis of the regenerated audio signal of the current frame; wherein the sinusoidal tracking unit performs tracking of the sinusoids of a next frame, by using the sinusoids directly extracted from the audio signal of the input current frame, or by using the sinusoids extracted from the regenerated audio signal of the current frame.

The bit number comparison unit may obtain a first encoding value, by encoding the birth sinusoids by applying parametric coding, and compares the number of bits of the first encoding value with a preset threshold.

The bit number comparison unit may obtain a first encoding value by applying parametric coding to the birth sinusoids, obtain a second encoding value by applying transform coding to the birth sinusoids, and compare the number of bits of the first encoding value with the number of bits of the second encoding value.

The first sinusoidal extraction unit may receive an audio signal of the next frame, and extract the sinusoids of the next frame by performing sinusoidal analysis of the audio signal of the next frame, and the sinusoidal tracking unit may, if the first bit number is less than the second bit number, perform tracking of the sinusoids of the next frame from the sinusoids directly extracted from the audio signal of the current frame, and, if the first bit number is greater than the second bit number, the sinusoidal tracking unit may perform tracking of the sinusoids of the next frame from the sinusoids extracted from the regenerated audio signal of the current frame.

The transform coding may include AAC.

According to another aspect of the present invention, there is provided a method of encoding an audio signal, including: directly extracting sinusoids of a current frame from an input audio signal; if sinusoids of a previous frame are encoded by applying parametric coding, performing tracking of the sinusoids of the current frame by using the sinusoids of the previous frame; and if the sinusoids of the previous frame are encoded by applying transform coding, decoding data which is encoded by applying the transform coding, by applying an inverse transform of the transform coding, extracting sinusoids from the decoded data, and performing tracking of the sinusoids of the current frame, by using the sinusoids extracted from the decoded data.

According to another aspect of the present invention, there is provided an apparatus for encoding an audio signal, including: a sinusoidal extraction unit extracting sinusoids of a current frame from an input audio signal; a first tracking unit, if sinusoids of a previous frame are encoded by applying parametric coding, performing tracking of the sinusoids of the current frame by using the sinusoids of the previous frame; and a second tracking unit, if the sinusoids of the previous frame are encoded by applying transform coding, decoding data which is encoded by applying the transform coding, by applying an inverse transform of the transform coding, extracting sinusoids from the decoded data, and performing tracking of the sinusoids of the current frame by using the sinusoids extracted from the decoded data.

By applying transform coding instead of parametric coding to a frame having many birth sinusoids, the sinusoids are encoded, thereby reducing the number of bits required for the encoding and enabling efficient coding.

Also, when transform coding is applied to a frame of a predetermined interval, an inverse transform of the transform coding is applied to the encoded data in order to decode the data, and then sinusoids are extracted from the decoded data, thereby enabling tracking of sinusoids of the next frame.

### BRIEF DESCRIPTION OF THE DRAWINGS

The above and other aspects of the present invention will become more apparent by describing in detail exemplary embodiments thereof with reference to the attached drawings in which:

FIG. 1 is a diagram for explaining a conventional parametric coding method according to the related art;

FIG. 2 is a diagram illustrating an apparatus for extracting a sinusoid from an audio signal and encoding the sinusoid according to the related art;

FIG. 3 is a diagram for explaining a tracking process performed in the apparatus illustrated in FIG. 2 according to the related art;

FIG. 4 is a block diagram illustrating a structure of an apparatus for encoding an audio signal, according to an exemplary embodiment of the present invention;

FIG. 5 is a flowchart illustrating a method of encoding an audio signal, according to an exemplary embodiment of the present invention;

FIG. 6 is a diagram for explaining an audio signal tracking process performed using a method of encoding an audio signal, according to an exemplary embodiment of the present invention; and

FIG. 7 is a block diagram illustrating a structure of an apparatus for encoding an audio signal, according to an exemplary embodiment of the present invention.

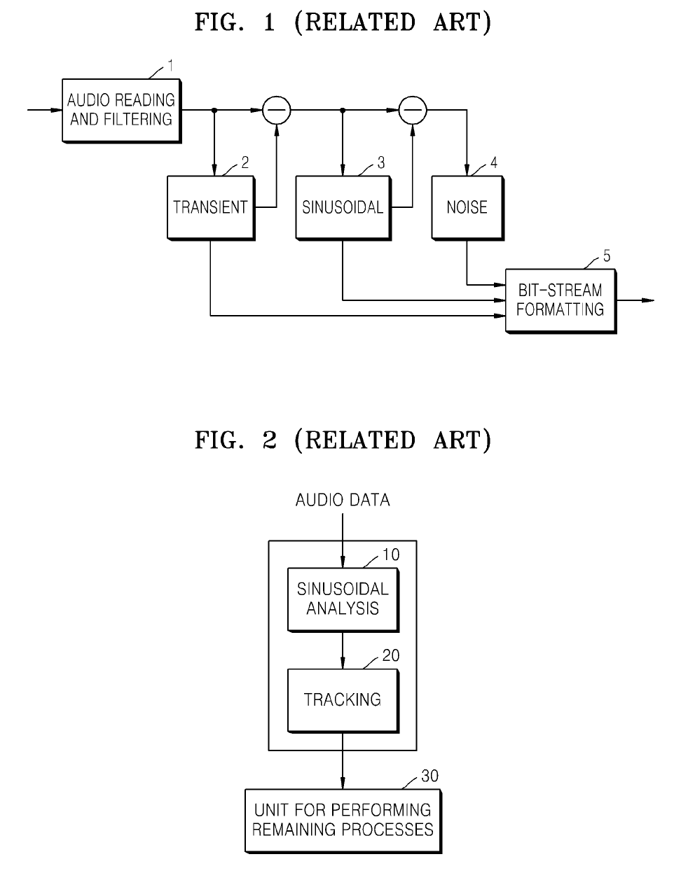

### DETAILED DESCRIPTION OF EXEMPLARY EMBODIMENTS OF THE INVENTION

The present invention will now be described more fully with reference to the accompanying drawings, in which exemplary embodiments of the invention are shown.

FIG. 2 is a diagram illustrating an apparatus for extracting a sinusoid from an audio signal and encoding the sinusoid according to the related art.

Referring to FIG. 2, the apparatus includes a sinusoidal analysis module 10, a tracking module 20, and a unit for performing remaining processes 30. If an audio signal is input to the apparatus, sinusoids of a current frame are extracted in the sinusoidal analysis module 10. In the tracking module 20, a sinusoid from among the sinusoids of the current frame similar to a sinusoid of a previous frame is identified and connected to the similar sinusoid. The sinusoid continuing from the previous sinusoid is referred to as a continuation sinusoid.

In the unit for performing remaining processes 30, the remaining processes of ordinary parametric coding are performed for the sinusoid obtained through the tracking, by using frequency, amplitude, and phase components.

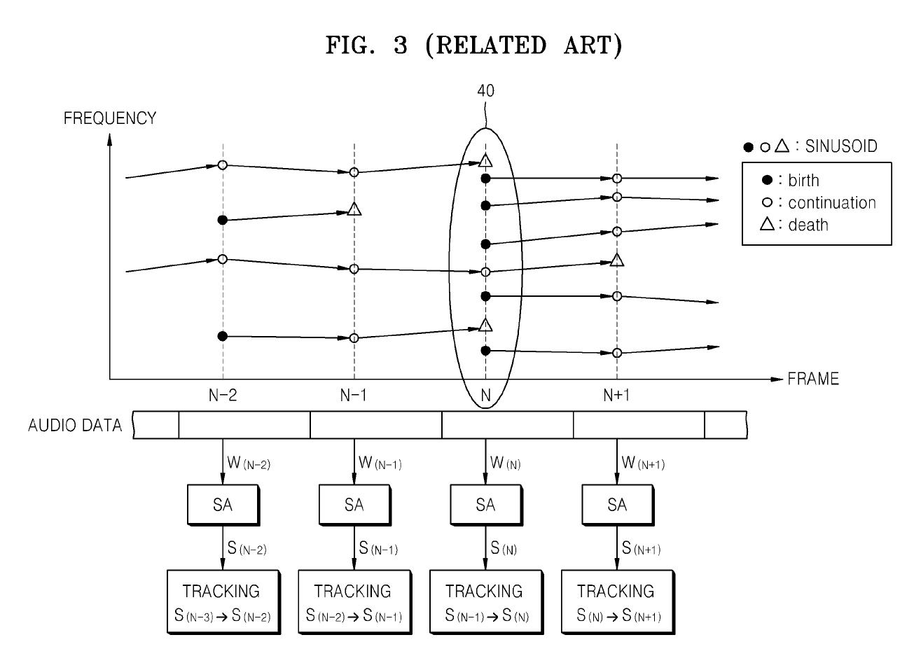

FIG. 3 is a diagram for explaining a tracking process performed in the apparatus illustrated in FIG. 2, according to the related art.

Referring to FIG. 3, a birth sinusoid is expressed by and a continuation sinusoid is expressed by ◯. A continuation sinusoid which ends without continuing to a sinusoid of a next frame is referred to as a death sinusoid. In FIG. 3, the death sinusoid is expressed by Δ.

FIG. 3 illustrates an example in which an N-th frame 40 includes eight sinusoids.

The eight sinusoids include three continuation sinusoids. Death sinusoids are also continuation sinusoids.

When the continuation sinusoids are encoded, difference coding is performed by using continuing sinusoids of an (N−1)-th frame, thereby enabling efficient coding. However, in order to encode a birth sinusoid, absolute coding of amplitude, frequency, and phase components should be performed, thereby requiring a large number of bits. In the N-th frame 40 illustrated in FIG. 3, five of the eight sinusoids are birth sinusoids.

In the case of the N-th frame 40 illustrated in FIG. 3, transform coding (or TF coding) enables reduction of the number of bits required for the encoding compared to parametric coding, and therefore is more efficient. In the present invention, in an interval having many birth sinusoids, transform coding instead of parametric coding is performed.

Transform coding is a coding method of transforming a signal in the time domain into a signal in the frequency domain. Examples of transform coding include MPEG-series encoding methods such as MP3, and advanced audio coding (AAC).

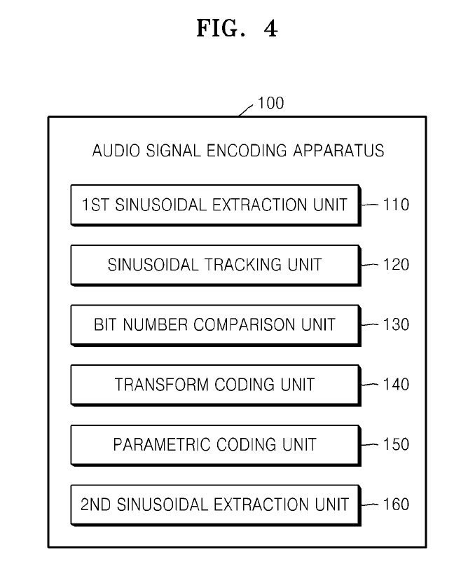

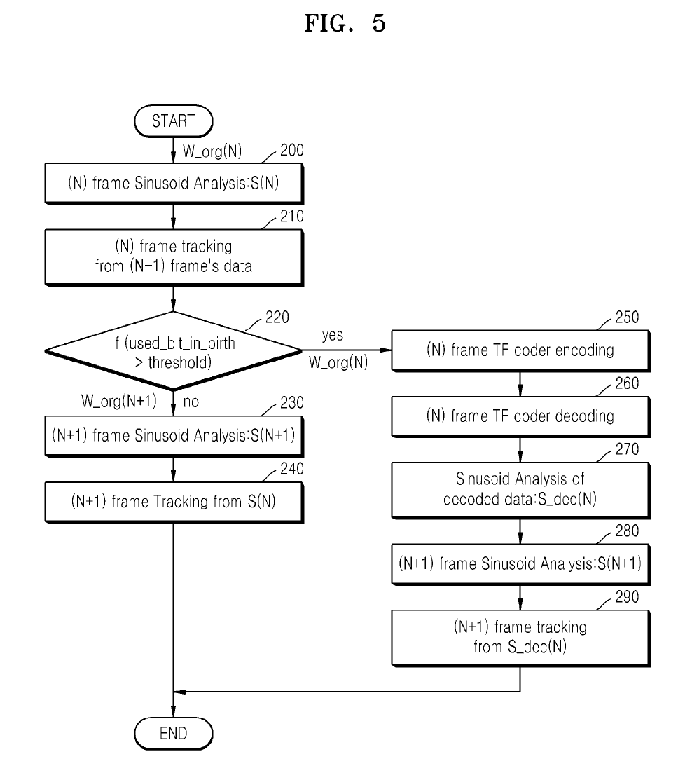

FIG. 4 is a block diagram illustrating a structure of an apparatus 100 for encoding an audio signal, according to an exemplary embodiment of the present invention. FIG. 5 is a flowchart illustrating a method of encoding an audio signal, performed using the apparatus 100 for encoding an audio signal, according to an exemplary embodiment of the present invention.

Referring to FIG. 4, the apparatus 100 for encoding an audio signal according to the exemplary embodiment may include a first sinusoidal extraction unit 110, a sinusoidal tracking unit 120, a bit number comparison unit 130, a transform coding unit 140, a parametric coding unit 150, and a second sinusoidal extraction unit 160.

The first sinusoidal extraction unit 110 receives an input of an audio signal of a current frame, performs sinusoidal analysis (SA), and extracts sinusoids (S(N)) of the current frame in operation 200.

The sinusoidal tracking unit 120 tracks the sinusoids (S(N)) of the current frame in relation to sinusoids (S(N−1)) of the previous frame, thereby obtaining continuation sinusoids and birth sinusoids in operation 210.

The bit number comparison unit 130 compares a first bit number and a second bit number in operation 220. In the present invention, the number of bits required for encoding a birth sinusoid by applying parametric coding will be referred to as a first bit number. The number of bits required for encoding a birth sinusoid by applying transform coding will be referred to as a second bit number.

FIG. 5 illustrates an exemplary embodiment in which the first bit number is indicated by used_bit_in_birth and a preset threshold is used as the second bit number in operation 220.

In another exemplary embodiment of the present invention, parametric coding may be applied to a birth sinusoid, thereby obtaining a first encoding value and using the number of bits of the first encoding value as a first bit number, and also, transform coding may be applied to a birth sinusoid, thereby obtaining a second encoding value and using the number of bits of the second encoding value as a second bit number.

When the first bit number is less than the second bit number, encoding of the birth sinusoid by applying parametric coding is more efficient. If the first bit number is less than the second bit number, the parametric coding unit 150 encodes sinusoids of a current frame, by applying parametric coding (not shown).

When the first bit number is greater than the second bit number, encoding of the birth sinusoid by applying transform coding is more efficient. If the first bit number is greater than the second bit number, the transform coding unit 140 encodes sinusoids of a current frame, by applying transform coding in operation 250.

When encoding of sinusoids of a current frame is performed by applying parametric coding, a decoding side can obtain the sinusoids of the current frame, by decoding the encoded data, and therefore tracking between the sinusoids of the current frame and the sinusoids of the next frame can be performed without any problem.

Accordingly, when the first number is less than the second number, the audio signal of the next frame can be encoded by applying an ordinary parametric coding method. The first sinusoidal extraction unit 110 receives the audio signal of the next frame, and performs sinusoidal analysis, thereby extracting the sinusoids (S(N+1)) of the next frame in operation 230. The sinusoidal tracking unit 120 performs tracking of the sinusoids (S(N+1)) of the next frame from the sinusoids (S(N)) directly extracted from the audio signal of the current frame in operation 240.

Meanwhile, when encoding of sinusoids of a current frame is performed by applying transform coding (in the case of operation 250), a decoding unit should decode the encoded data, by applying an inverse transform of the transform coding. However, in this case, the sinusoids of the current frame do not directly appear in the decoded data. Accordingly, the decoding unit should again perform sinusoidal analysis of the decoded audio signal, extract the sinusoid, and then perform tracking of the sinusoids of the next frame.

However, the sinusoids extracted from the decoded data may be different from the sinusoids extracted from the original input audio signal. Accordingly, the encoding unit should perform tracking of the audio signal of the next frame, by using sinusoids obtained by performing the same process as performed by the decoding unit.

If the first bit number is greater than the second bit number, the second sinusoidal extraction unit 160 decodes the encoded data, which is encoded by the transform coding unit 140 by applying transform coding, by applying inverse transform of the transform coding, thereby regenerating the audio signal of the current frame in operation 260. Then, the second sinusoidal extraction unit 160 performs sinusoidal analysis of the regenerated audio signal of the current frame, thereby extracting the sinusoids (S_dec(N)) of the current frame in operation 270.

In order to obtain the sinusoids of the next frame, the first sinusoidal extraction unit 110 receives the audio signal of the next frame, performs sinusoidal analysis, and extracts the sinusoids (S(N+1)) of the next frame in operation 280.

Then, the sinusoidal tracking unit 120 performs tracking of the sinusoids (S(N+1)) of the next frame from the regenerated sinusoids (S_dec(N)) extracted from the audio signal of the current frame in operation 290.

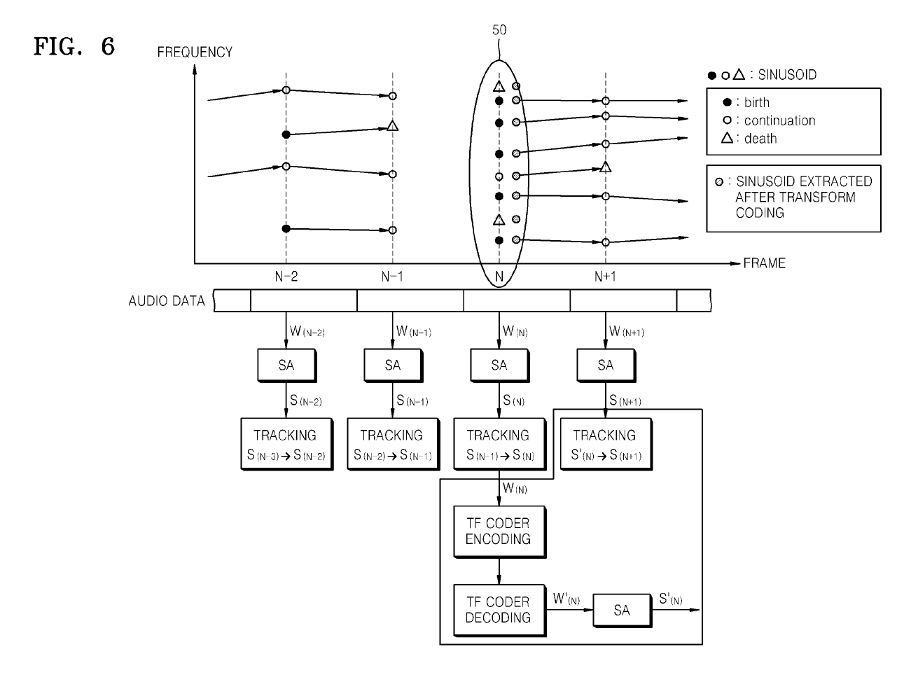

FIG. 6 is a diagram for explaining an audio signal tracking process performed using a method of encoding an audio signal, according to an exemplary embodiment of the present invention.

Referring to FIG. 6, an N-th frame 50 includes a plurality of birth sinusoid signals. If a method of encoding an audio signal according to the present invention is performed, the sinusoid signals (S(N)) of the current frame are encoded by applying transform coding. The encoded data is decoded by applying inverse transform of the transform coding, thereby regenerating the audio signal of the current frame. In FIG. 6, the regenerated audio signal is expressed as W′(N).

Sinusoidal analysis of the regenerated audio signal W′(N) is performed, thereby extracting the sinusoids (S′(N)) of the current frame.

For tracking of the sinusoids of the next frame, the sinusoids S′(N) of the current frame extracted from the regenerated audio signal are used.

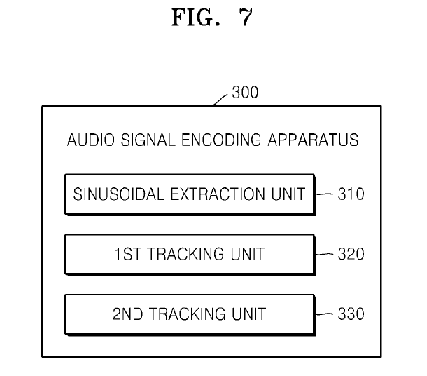

FIG. 7 is a block diagram illustrating a structure of an apparatus 300 for encoding an audio signal, according to an exemplary embodiment of the present invention. Referring to FIG. 7, the apparatus 300 for encoding an audio signal according to the exemplary embodiment may include a sinusoidal extraction unit 310, a first tracking unit 320, and a second tracking unit 330.

The apparatus 300 for encoding an audio signal illustrated in FIG. 7 is for encoding the next frame described with reference to FIGS. 4 and 5.

That is, a current frame in FIG. 7 corresponds to the next frame described with reference to FIGS. 4 and 5, and a previous frame in FIG. 7 corresponds to the current frame described with reference to FIGS. 4 and 5.

The sinusoidal extraction unit 310 extracts the sinusoids of the current frame from an input audio signal. This corresponds to operation 230 or 280 illustrated in FIG. 5.

When the sinusoids of the previous frame are encoded by applying parametric coding, the first tracking unit 320 performs tracking of the sinusoids of the current frame, by directly using the sinusoids of the previous frame. This corresponds to operation 240 illustrated in FIG. 5.

When the sinusoids of the previous frame are encoded by applying transform coding, the second tracking unit 330 decodes the encoded data, which is encoded by applying transform coding, by applying inverse transform of the transform coding, and extracts the sinusoids from the decoded data. These operations correspond to operations 260 and 270, respectively, illustrated in FIG. 5.

Also, the second tracking unit 330 performs tracking of the sinusoids of the current frame, by using the sinusoids extracted from the decoded data. This operation corresponds to operation 290 illustrated in FIG. 5.

The present invention relates to encoding and decoding of an audio signal. The present invention is used for encoding an audio stream, and is used for a data storage medium storing the audio stream.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of encoding an audio signal, the method comprising:
directly extracting sinusoids of a current frame of an input signal, by performing sinusoidal analysis of an audio signal of the current frame;
obtaining continuation sinusoids and birth sinusoids, by performing tracking of the sinusoids of the current frame, from sinusoids of a previous frame of the input signal;
comparing a first bit number which is a number of bits required for encoding the birth sinusoids by applying parametric coding, with a second bit number which is a number of bits required for encoding the birth sinusoids by applying transform coding, and determining whether or not the first bit number is greater than the second bit number;
encoding the sinusoids of the current frame by applying parametric coding, if the first bit number is less than the second bit number;
encoding the sinusoids of the current frame by applying transform coding, if the first bit number is greater than the second bit number;
regenerating the audio signal of the current frame by decoding data of the current frame encoded by the transform coding by applying an inverse transform of the transform coding, and extracting sinusoids from the regenerated audio signal of the current frame by performing sinusoidal analysis of the regenerated audio signal of the current frame, if the first bit number is greater than the second bit number; and
performing tracking of the sinusoids of a next frame of the input signal, by using the sinusoids directly extracted from the current frame, or by using the sinusoids extracted from the regenerated audio signal of the current frame.

2. The method of claim 1, wherein the comparing the first bit number with the second bit number comprises:
obtaining a first encoding value, by encoding the birth sinusoids by applying parametric coding; and
comparing a number of bits of the first encoding value with a preset threshold.

3. The method of claim 1, wherein the comparing the first bit number with the second bit number comprises:
obtaining a first encoding value, by applying parametric coding to the birth sinusoids;
obtaining a second encoding value, by applying transform coding to the birth sinusoids; and
comparing a number of bits of the first encoding value with a number of bits of the second encoding value.

4. The method of claim 1, wherein the performing tracking of the sinusoids of the next frame comprises:
receiving an audio signal of the next frame;
extracting sinusoids of the next frame, by performing sinusoidal analysis of an audio signal of the next frame;
performing tracking of the sinusoids of the next frame from the sinusoids directly extracted from the current frame, if the first bit number is less than the second bit number; and
performing tracking of the sinusoids of the next frame from the sinusoids extracted from the regenerated audio signal of the current frame, if the first bit number is greater than the second bit number.

5. The method of claim 1, wherein the transform coding comprises Advanced Audio Coding (AAC).

6. An apparatus for encoding an audio signal, the apparatus comprising:
a first sinusoidal extraction unit which directly extracts sinusoids of a current frame of an input signal, by performing sinusoidal analysis of an audio signal of the current frame;
a sinusoidal tracking unit which obtains continuation sinusoids and birth sinusoids, by performing tracking of the sinusoids of the current frame from sinusoids of a previous frame of the input signal;
a bit number comparison unit which compares a first bit number which is a number of bits required for encoding the birth sinusoids by applying parametric coding, with a second bit number which is a number of bits required for encoding the birth sinusoids by applying transform coding, and determines whether or not the first bit number is greater than the second bit number;
a parametric coding unit which encodes the sinusoids of the current frame by applying parametric coding if the first bit number is less than the second bit number;
a transform coding unit which encodes the sinusoids of the current frame by applying transform coding if the first bit number is greater than the second bit number; and
a second sinusoidal extraction unit which, if the first bit number is greater than the second bit number, regenerates the audio signal of the current frame by decoding the encoded data of the current frame encoded by the transform coding by applying an inverse transform of the transform coding, and extracts sinusoids from the regenerated audio signal of the current frame by performing sinusoidal analysis of the regenerated audio signal of the current frame,
wherein the sinusoidal tracking unit performs tracking of the sinusoids of a next frame of the input signal, by using the sinusoids directly extracted from the current frame, or by using the sinusoids extracted from the regenerated audio signal of the current frame.

7. The apparatus of claim 6, wherein the bit number comparison unit obtains a first encoding value by encoding the birth sinusoids by applying parametric coding, and compares a number of bits of the first encoding value with a preset threshold.

8. The apparatus of claim 6, wherein the bit number comparison unit obtains a first encoding value by applying parametric coding to the birth sinusoids, obtains a second encoding value by applying transform coding to the birth sinusoids, and compares a number of bits of the first encoding value with a number of bits of the second encoding value.

9. The apparatus of claim 6, wherein the first sinusoidal extraction unit receives an audio signal of the next frame, and extracts sinusoids of the next frame by performing sinusoidal analysis of an audio signal of the next frame, and
wherein the sinusoidal tracking unit performs tracking of the sinusoids of the next frame from the sinusoids directly extracted from the current frame, if the first bit number is less than the second bit number; and
wherein the sinusoidal tracking unit performs tracking of the sinusoids of the next frame from the sinusoids extracted from the regenerated audio signal of the current frame, if the first bit number is greater than the second bit number.

10. The apparatus of claim 6, wherein the transform coding comprises Advanced Audio Coding (AAC).

11. A method of encoding an audio signal, the method comprising:
extracting sinusoids of a current frame from an input audio signal;
performing tracking of the sinusoids of the current frame by using sinusoids of a previous frame of the audio signal if sinusoids of the previous frame are encoded by applying parametric coding; and
decoding data of the current frame which is encoded by transform coding by applying an inverse transform of the transform coding, extracting sinusoids from the decoded data, and performing tracking of the sinusoids of the current frame by using the extracted sinusoids, if the sinusoids of the previous frame are encoded by transform coding.

12. An apparatus for encoding an audio signal, the apparatus comprising:
a sinusoidal extraction unit which extracts sinusoids of a current frame from an input audio signal;
a first tracking unit which performs tracking of the sinusoids of the current frame by using sinusoids of a previous frame of the audio signal if sinusoids of the previous frame are encoded by applying parametric coding; and
a second tracking unit which, if the sinusoids of the previous frame are encoded by transform coding, decodes data of the current frame which is encoded by transform coding by applying an inverse transform of the transform coding, extracts sinusoids from the decoded data, and performs tracking of the sinusoids of the current frame by using the extracted sinusoids.

13. A computer readable recording medium having embodied thereon a computer program for executing a method of encoding an audio signal, the method comprising:
directly extracting sinusoids of a current frame of an input signal, by performing sinusoidal analysis of an audio signal of the current frame;
obtaining continuation sinusoids and birth sinusoids, by performing tracking of the sinusoids of the current frame, from sinusoids of a previous frame of the input signal;
comparing a first bit number which is a number of bits required for encoding the birth sinusoids by applying parametric coding, with a second bit number which is a number of bits required for encoding the birth sinusoids by applying transform coding, and determining whether or not the first bit number is greater than the second bit number;
encoding the sinusoids of the current frame by applying parametric coding, if the first bit number is less than the second bit number;
encoding the sinusoids of the current frame by applying transform coding, if the first bit number is greater than the second bit number;
regenerating the audio signal of the current frame by decoding data of the current frame encoded by the transform coding by applying an inverse transform of the transform coding, and extracting sinusoids from the regenerated audio signal of the current frame by performing sinusoidal analysis of the regenerated audio signal of the current frame, if the first bit number is greater than the second bit number; and
performing tracking of the sinusoids of a next frame of the input signal, by using the sinusoids directly extracted from the current frame, or by using the sinusoids extracted from the regenerated audio signal of the current frame.

14. A computer readable recording medium having embodied thereon a computer program for executing a method of encoding an audio signal, the method comprising:
extracting sinusoids of a current frame from an input audio signal;
performing tracking of the sinusoids of the current frame by using sinusoids of a previous frame of the audio signal if sinusoids of the previous frame are encoded by applying parametric coding; and
decoding data of the current frame which is encoded by transform coding by applying an inverse transform of the transform coding, extracting sinusoids from the decoded data, and performing tracking of the sinusoids of the current frame by using the extracted sinusoids, if the sinusoids of the previous frame are encoded by transform coding.
